(19) United States
(12) Patent Application Publication
(10) Pub. No.: US 2013/0160558 A1
(43) Pub. Date: Jun. 27, 2013

(54) PHOTOACOUSTIC IMAGING APPARATUS AND CONTROL METHOD THEREOF

(71) Applicant: Takuji Oishi, Kyoto-shi (JP)

(72) Inventor: Takuji Oishi, Kyoto-shi (JP)

(73) Assignee: CANON KABUSHIKI KAISHA, Tokyo (JP)

(21) Appl. No.: 13/820,674

(22) PCT Filed: Sep. 9, 2011
(86) PCT No.: PCT/JP2011/005060

§ 371 Date: Mar. 4, 2013

(30) Foreign Application Priority Data
Sep. 14, 2010 (JP) 2010-205926

(51) Int. Cl. G01N 21/17

(52) U.S. Cl. CPC G01N 21/1702
USPC 73/655

(57) ABSTRACT

A photoacoustic imaging apparatus is used that comprises a light source capable of irradiating light onto an object from a plurality of directions, a detector that detects acoustic waves generated by the object irradiated with light, a calculator that calculates object information from detected acoustic waves, and a generator that generates image data from the object information. The calculator calculates a plurality of object information pieces corresponding to irradiation in respective directions on the basis of acoustic waves at a time of irradiation of light at dissimilar timings from the plurality of directions. The generator selects, for each region and according to a predetermined criterion, image data of increased contrast in a case where a plurality of image data items on the object are generated on the basis of the plurality of object information pieces, and generates image data by combining the image data selected in each region.

### TECHNICAL FIELD

The present invention relates to an imaging apparatus that exploits photoacoustic effects, and to a control method of the imaging apparatus.

### BACKGROUND ART

Imaging apparatus that rely on X-rays or ultrasound waves are used in numerous fields, in particular, in the medical field where non-destructive testing is required. In the medical field, physiological information on a living body, i.e. functional information, is effective for locating sites of diseases such as cancer. Imaging of functional information has therefore been the object of ongoing research. However, X-ray diagnosis and ultrasound diagnosis afford only morphological information on the interior of the living body. Therefore, photoacoustic tomography (PAT), which is an optical imaging technology, has been proposed as a non-invasive diagnosis method that enables imaging of functional information.

Photoacoustic tomography is a technology wherein pulsed light generated by a light source is irradiated onto an object and the energy of light propagating/diffusing within the object is absorbed by biological tissue. The latter generates thereupon acoustic waves that are received by an acoustic detector and are transformed into images. In photoacoustic tomography, the changes over time in the received acoustic waves are detected at a plurality of sites that surround the object. The detected signals are subjected to mathematical analysis, i.e. are reconstructed, to visualize in three dimensions object information associated with optical characteristic values of the interior of the object.

Photoacoustic tomography allows obtaining optical characteristic value distributions, for instance a light absorption coefficient distribution in the living body, on the basis of an initial pressure generation distribution in the object, and allows obtaining information on the interior of the object. Near-infrared light passes readily through water, which makes up most of the living body, and is readily absorbed by hemoglobin in blood. Blood vessel images can thus be captured using near-infrared light.

However, blood vessels having light-absorbing hemoglobin are present over wide regions in the living body, from the vicinity of the surface down to deep portions of the living body. The light that reaches down to the deep portions of the living body is attenuated and weak, and the resulting signal (acoustic wave intensity) is likewise weak. The contrast of the image is thus low, which makes blood vessel imaging difficult.

In Non-patent Literature 1, the acoustic detector and the pulsed light incidence direction are at opposing positions flanking the object. In Patent Literature 1, by contrast the acoustic detector and the pulsed light incidence direction are on the same side of the object. Therefore, the techniques of Non-patent Literature 1 and Patent Literature 1 could conceivably be combined so that pulsed light is irradiated onto the object from both sides, thereby enhancing deep-portion contrast by causing a greater amount of light to strike the interior of the object.

### CITATION LIST

### Patent Literature

### [PTL 1]

US Patent Application Publication No. 2006/0184042

### Non Patent Literature

### [NPL 1]

S. Manohar et al, Proc. of SPIE vol. 6437 643702-1

### SUMMARY OF INVENTION

### Technical Problem

As described above, contrast in the vicinity of a light irradiation surface can be increased by causing light to strike the object from two sides and arranging an acoustic detector at a light incidence surface on one side, as compared with a below-described transmissive system. However, the above approach is problematic in that, conversely, contrast deteriorates at regions deeper than a given depth.

In order to explain this mechanism, an irradiation system will be defined as in FIGS. 1A to 1C. As illustrated in FIG. 1A, a two-side irradiation system has a configuration wherein light is irradiated from two sides onto an object, and signals are obtained by an acoustic detector that is disposed at a light incidence surface on one side. As illustrated in FIG. 1B, a transmissive irradiation system has a configuration wherein light is irradiated onto an object from one side, and signals are obtained by an acoustic detector disposed at the surface on the side opposite to the light incidence surface. As illustrated in FIG. 1C, a reflective irradiation system has a configuration wherein light is irradiated onto an object from one side, and signals are obtained by an acoustic detector disposed at the same surface as the light incidence surface.

When pulsed light strikes the object, acoustic waves that are generated by a light absorber present in the interior of the object are generated at the point in time where pulsed light is irradiated, and propagate then through the object. As a result, the signal (absorber signal) corresponding to the acoustic wave generated by the light absorber is obtained later than the point in time of light irradiation. Acoustic waves are also generated at the interface with the object. However, signals corresponding to acoustic waves generated at the interface (interface signals) exhibit ringing all the while, giving rise to noise, on account of, for instance, acoustic reflection and the band of the acoustic detector. If there are any layers, for instance those of an object holding plate, between the object and the acoustic detector, the acoustic waves generated at the interface undergo multiple reflections at those layers, giving rise to further noise.

The influence of the occurrence of noise in the various irradiation systems is discussed next. In transmissive systems, an interface signal is acquired after the absorber signal. Therefore, subsequent noise and the absorber signal do not overlap each other. In reflective systems, the interface signal is obtained initially, and subsequent noise and the absorber signal overlap each other, whereby contrast is impaired. In two-side systems, as in the case of reflective systems, the interface signal is obtained initially, and subsequent noise and the absorber signal overlap each other, whereby contrast is impaired. At deeper locations than a given depth, the contribution to contrast lowering on account of overlap with noise due to the interface signal is greater than the contrast improvement achieved by increasing the amount of light. As a result, contrast drops more than in the case of transmissive systems, where light irradiation comes from one side.

The problem of noise derived from the interface signal occurs when the sensitivity of the acoustic detector exists at the interface of the object with the acoustic detector, i.e. upon irradiation of light within a view angle range. This kind of irradiation is called bright field irradiation. In bright field irradiation, the interface acoustic signal is detected directly by the acoustic detector, and noise becomes a problem as a result. The explanation hereafter will assume bright field irradiation in a two-side system and a reflective irradiation system.

In the light of the above, it is an object of the present invention to provide a technology that enables a photoacoustic imaging apparatus to obtain image data of high contrast over a wider area of an object than in the case of conventional irradiation systems.

### Solution to Problem

The present invention has the features below. Specifically, the present invention is a photoacoustic imaging apparatus comprising: a light source capable of irradiating light onto an object from a plurality of directions; a detector that detects acoustic waves generated by the object irradiated with light; a calculator that calculates object information on the basis of acoustic waves detected by the detector; and a generator that generates image data of the object on the basis of the object information, wherein the calculator calculates a plurality of object information pieces corresponding to irradiation in respective directions on the basis of acoustic waves generated upon irradiation of light onto the object at dissimilar timings from the plurality of directions, and the generator selects, for each region in the object and according to a predetermined criterion, image data of increased contrast in a case where a plurality of image data items on the object are generated on the basis of the plurality of object information pieces, and generates image data by combining the image data selected in each region.

The present invention has also the features below. Specifically, the present invention is a control method of a photoacoustic imaging apparatus that includes a light source capable of irradiating light onto an object from a plurality of directions; a detector that detects acoustic waves generated by the object irradiated with light; a calculator that calculates object information on the object on the basis of acoustic waves detected by the detector; and a generator that generates image data of the object on the basis of the object information, the method comprising: a step of, by way of the light source, irradiating light onto the object at dissimilar timings from the plurality of directions; a step of, by way of the calculator, calculating a plurality of object information pieces corresponding to irradiation in respective directions, on the basis of acoustic waves generated upon the irradiation; and a step of, by way of the generator, selecting, for each region in the object and according to a predetermined criterion, image data of increased contrast in a case where a plurality of image data items on the object are generated on the basis of the plurality of object information pieces, and generating image data by compositing the image data selected in each region.

### Advantageous Effects of Invention

The present invention allows a photoacoustic imaging apparatus to obtain image data of high contrast over a wider area of an object than in the case of conventional irradiation systems.

Further features of the present invention will become apparent from the following description of exemplary embodiments with reference to the attached drawings.

### BRIEF DESCRIPTION OF DRAWINGS

FIGS. 1A to 1C are diagrams for explaining irradiation systems.

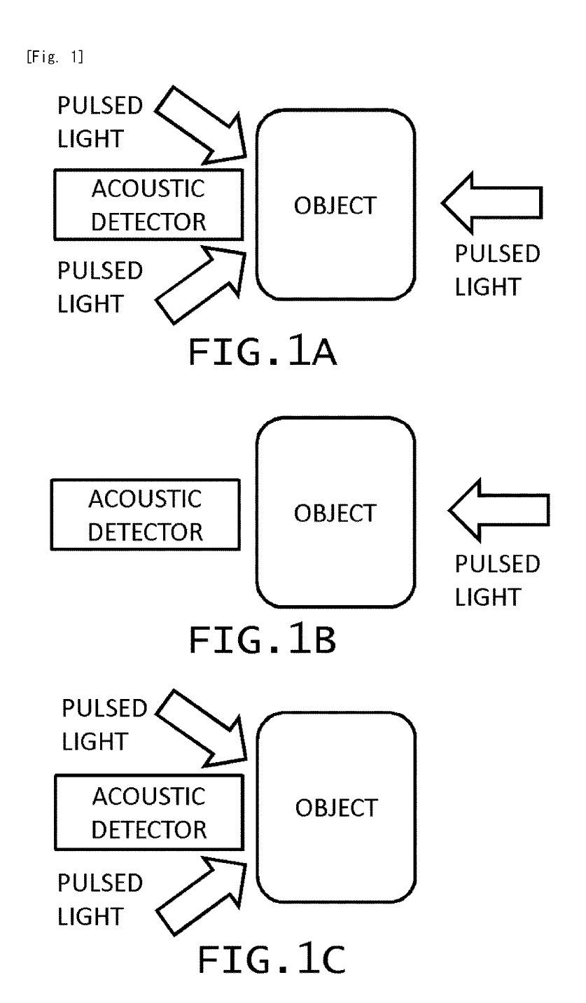

FIG. 2 is a schematic diagram illustrating the configuration of a device according to Embodiment 1.

FIG. 3 is a schematic diagram illustrating the flow of data processing in the device according to Embodiment 1.

FIG. 4 is a flow chart illustrating the operation of the device according to Embodiment 1.

FIG. 5 is a schematic diagram illustrating the configuration of a device according to Embodiment 4.

FIG. 6 is a schematic diagram illustrating the flow of data processing in the device according to Embodiment 4.

FIG. 7 is a flow chart illustrating the operation of the device according to Embodiment 4.

FIG. 8 is a diagram illustrating the relationship between contrast and distance from an acoustic detector in each irradiation system.

FIGS. 9A to 9D are diagrams illustrating obtained light absorption coefficient distributions according to each irradiation systems.

### DESCRIPTION OF EMBODIMENTS

Preferred embodiments of the present invention are explained below with reference to accompanying drawings. The explanation below deals with a photoacoustic imaging apparatus in which image data based on acoustic waves is generated using photoacoustic tomography technologies, and in which there are displayed images based on that image data. However, the applications in which the present invention is used do not necessarily require the presence of an image display device. The present invention may be a photoacoustic imaging apparatus in which image data items are stored and displayed on a display device.

In the present invention, the term acoustic wave includes elastic waves referred to as sound waves, ultrasound waves and photoacoustic waves. In the present invention, the term “object information” denotes a generation source distribution of acoustic waves generated as a result of light irradiation, an initial sound pressure distribution in the object, or a light energy absorption density distribution, a light absorption coefficient distribution, and a concentration distribution of tissue-constituent substances, as derived from the initial sound pressure distribution. The substance concentration distribution is, for instance, an oxygen saturation distribution, an oxy/deoxy hemoglobin concentration distribution, a collagen concentration distribution or the like.

### Embodiment 1

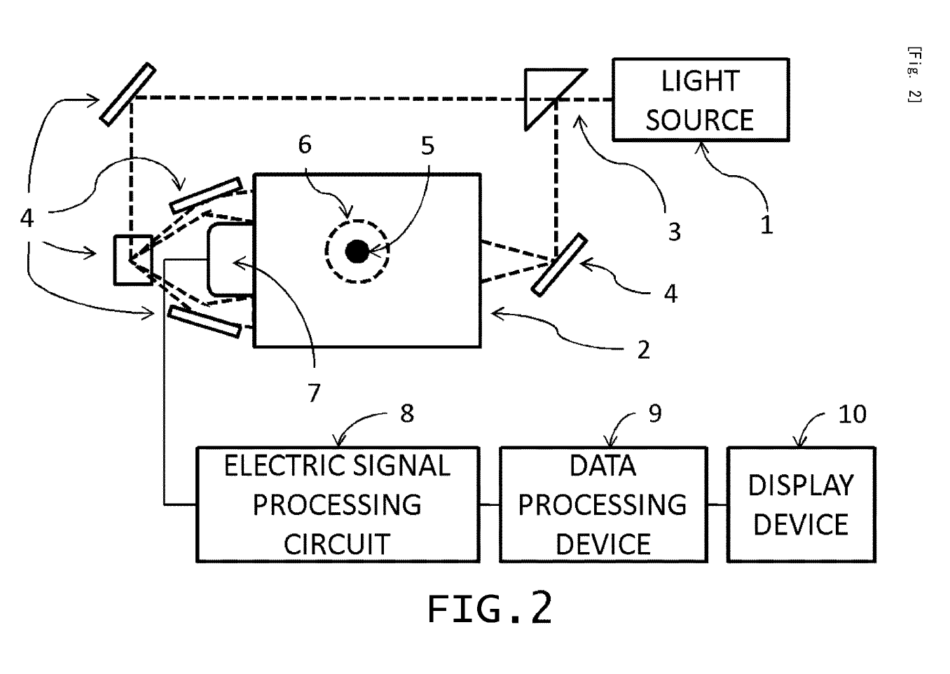

An explanation follows next, based on FIG. 2, on an imaging apparatus according to Embodiment 1, which is the basic embodiment of the present invention.

The imaging apparatus of the present embodiment comprises a light source 1 that irradiates pulsed light onto an object 2, an optical path switch 3 that switches the optical path of the pulsed light irradiated by the light source 1, and an optical component 4, such as a mirror or a lens, that guides the pulsed light. The imaging apparatus further comprises an array-type acoustic detector 7 that detects acoustic waves 6 generated by a light absorber 5 upon absorption of light energy and that converts the acoustic waves 6 into electric signals, and a electric signal processing circuit 8 that, for instance, amplifies or performs digital conversion on the electric signals. The imaging apparatus further comprises a data processing device 9 that constructs an image relating to information of the interior of the object, and a display device 10 that displays images.

The array-type acoustic detector 7 is an acoustic detector in which a plurality of elements that detect acoustic waves is arrayed in an in-surface direction, such that signals of a plurality of positions can be obtained simultaneously. For instance, a laser light source can be used as the light source 1. The light source 1 need only be capable of irradiating light onto an object from a plurality of directions at a same timing, or at different timings. The light from one light source may be switched or branched, as in the present embodiment. Alternatively, there may be provided a plurality of light sources, such that each of the light sources irradiates light. The array-type acoustic detector 7 corresponds to the detector of the present invention.

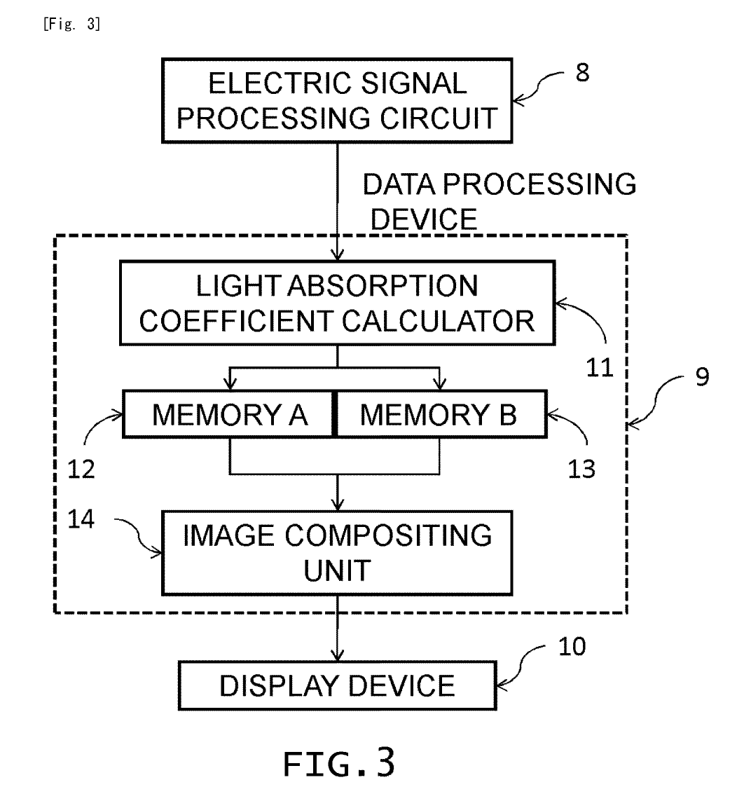

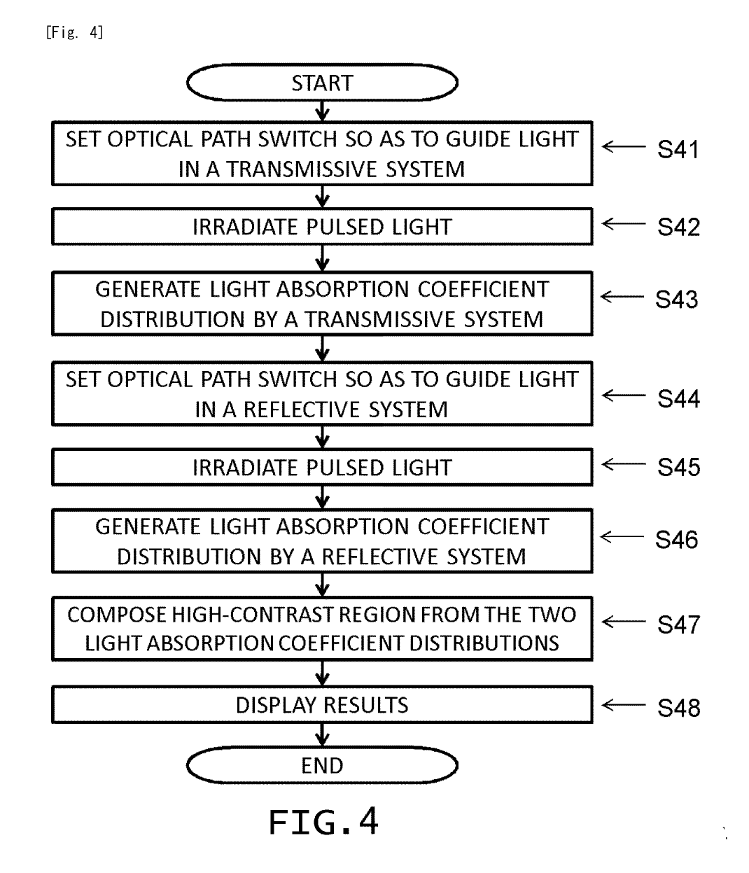

An implementation method of the present embodiment will be explained next based on FIG. 2, FIG. 3 and FIG. 4. FIG. 3 is a diagram illustrating the internal configuration and control flow of the data processing device 9. FIG. 4 is a flow diagram illustrating an implementation method of the present embodiment.

A light absorption coefficient calculator 11 in the data processing device 9 of FIG. 3 obtains a light absorption coefficient distribution, as object information of the interior of the object, on the basis of a digital signal generated by the electric signal processing circuit 8. Memory A 12 and memory B 13 are storage devices that store, respectively, an absorption coefficient distribution of a transmissive irradiation system and an absorption coefficient distribution of a reflective irradiation system. An image compositing unit 14 generates composite image data on the basis of the absorption coefficient distributions stored in the memory A and the memory B.

The light absorption coefficient calculator 11 corresponds to the calculator of the present invention. The image compositing unit 14 corresponds to the generator of the present invention.

In the flowchart of FIG. 4, firstly the optical path switch 3 is set so as to configure a transmissive irradiation system in which pulsed light is irradiated from a face opposing the array-type acoustic detector 7 (step S41). Next, pulsed light is irradiated from the light source 1 onto the object. The acoustic waves generated by the object that absorbs the light are acquired at a plurality of positions by the array-type acoustic detector 7, and are converted to respective electric signals (acoustic signals) (S42).

The light absorption coefficient calculator 11 in the data processing device 9 produces a light absorption coefficient distribution for a transmissive system using signals obtained as a result of the process that the electric signal processing circuit 8 performs on the acoustic signals, and the light absorption coefficient distribution is stored in the memory A 12 (S43).

Next, the optical path switch 3 is set so as to configure a reflective irradiation system in which pulsed light is irradiated from the same face as that of the array-type acoustic detector 7 (S44).

Thereafter, pulsed light is irradiated by the light source. The acoustic waves generated by the object that absorbs the light are acquired at a plurality of positions by the array-type acoustic detector 7, and are converted to respective electric signals (acoustic signals) (S45). The light absorption coefficient calculator 11 in the data processing device 9 produces a light absorption coefficient distribution for a reflective irradiation system using signals obtained as a result of the process that the electric signal processing circuit 8 performs on the acoustic signals, and the light absorption coefficient distribution is stored in the memory B 13 (S46).

In the image compositing unit 14, next, the light absorption coefficient distribution for a transmissive system and the light absorption coefficient distribution for a reflective system, stored in the memory A 12 and the memory B 13, are combined in accordance with a method described in detail below, following predetermined criteria, to generate composite image data (S47).

Lastly, the obtained composite image is displayed on the display device 10 (S48).

The processing method of the image compositing unit 14 is explained next. In the present embodiment, high-contrast regions are cut out of the light absorption coefficient distribution in a transmissive system and out of the light absorption coefficient distribution in a reflective system, and data items of the regions are joined together. The size and shape of the regions for contrast comparison can be set arbitrarily. The minimum unit is the pixel, which is the smallest constituent unit of the light absorption coefficient distribution. The regions of the object may be cut out according to the distance from the acoustic detector if the predetermined criterion for selecting the irradiation system used for image compositing is, for instance, a combination of a transmissive system and a reflective system.

In this case, contrast for each irradiation system may be obtained beforehand as a function of the distance from the acoustic detector, for instance through experimentation using a biological simulation material. The high-contrast regions are decided as regions to be cut out on the basis of the relationship thus obtained between contrast and the distance from the acoustic detector.

In actual living bodies, light absorption coefficients exhibit variability for each individual, and matching with a biological simulation material is not perfect. Therefore, the cut-out region decided herein is not necessarily optimal. However, the decided cut-out region is found to be effective if the optical characteristics and acoustic characteristics of the biological simulation material are roughly set in accordance with those of a living body. The data items of the cut-out regions decided on the basis of the light absorption coefficient distribution of the transmissive system and the light absorption coefficient distribution of the reflective system are cut out and joined together to yield single data. As described above, the process of the present embodiment allows obtaining a high-contrast image through joining of high-contrast regions.

The present embodiment has been explained based on an example of a light absorption coefficient distribution as the acquired object information, but the present invention is not limited thereto. In the present invention, object information may be calculated in the form of, for instance, an initial sound pressure distribution within the object, or a light energy absorption density distribution, or light absorption coefficient distribution, or a concentration distribution such as an oxygen saturation distribution, derived from the initial sound pressure distribution. High-contrast image data can be generated, for each distribution, by comparing object information at each irradiation direction, and by cutting out and combining the respective data items. In the below-described embodiments, likewise, examples of light absorption coefficient distribution are explained, but the embodiments are not limited thereto, and object information may be calculated in the form of, for instance, an initial sound pressure distribution within the object, or a light energy absorption density distribution, or light absorption coefficient distribution, or a concentration distribution such as a oxygen saturation distribution, derived from the initial sound pressure distribution.

### Embodiment 2

A combination of a transmissive irradiation system and a reflective irradiation system was explained in Embodiment 1. In Embodiment 2 an irradiation system combination will be explained that is different from that explained in Embodiment 1.

The present invention is effective in the case of a combination of an irradiation system in which pulsed light is irradiated from a face on a side different from the acoustic detector side, and an irradiation system that includes a reflective system. For instance, the combination may be an irradiation system in which pulsed light is incident from a direction perpendicular to a surface at which the acoustic detector comes into contact with the object, plus a reflective irradiation system. In another example, the combination may include a transmissive irradiation system plus a two-side irradiation system. The optical path of Embodiment 1 can be implemented thus by re-combining irradiation systems. A high-contrast image can be obtained, as in Embodiment 1, through joining of high-contrast regions on the basis of the obtained light absorption coefficient distributions from the two irradiation systems.

The combination of irradiation systems is not limited to two types of system, and may involve three or more types of system. For instance, the combination may be a triple combination of an irradiation system in which pulsed light is incident from a direction perpendicular to the surface at which the acoustic detector comes into contact with the object, a transmissive irradiation system, and a reflective irradiation system. The present invention can be realized by producing an individual light absorption coefficient distribution for each of the irradiation systems, and by cutting out and then joining high-contrast regions from the respective light absorption coefficient distributions, on the basis of, for instance, contrast that has been measured beforehand.

A method where three or more types are combined affords high-contrast images over a greater area than when two types of method are combined.

### Embodiment 3

The processing method performed in the image compositing unit 14 is not limited to the method described in Embodiment 1. Embodiment 3 described herein is identical to Embodiment 1, except for the processing method in the image compositing unit 14. An explanation follows next on the predetermined criterion for selecting the irradiation system that is used in the present embodiment for compositing image data items. The present embodiment is not limited to selecting only one irradiation system for each region of the object, and there may be selected image data items obtained for a plurality of irradiation systems, and the image data items may be composited using a weighting coefficient.

In the present embodiment, experiments or the like are performed beforehand using a biological simulation material, and contrast is obtained as a function of the distance from the acoustic detector, for each of a transmissive and a reflective irradiation system. Next, each light absorption coefficient distribution is multiplied by a weighting coefficient in accordance with the obtained contrast, for each distance from the acoustic detector. Lastly, the weighted light absorption coefficient distributions are summated. This process is not limited to summation, and may be a multiplication.

This method allows avoiding the occurrence of unnatural jumps in the joined portions of Embodiment 1.

Combinations of image data in the present invention encompass configurations in which image data items are joined together as in Embodiment 1, and configurations in which image data items are composited through summation or multiplication with each other as in Embodiment 3.

### Embodiment 4

In Embodiment 4 there is explained an instance where the present invention is used for wide-range imaging through displacement of the acoustic detector.

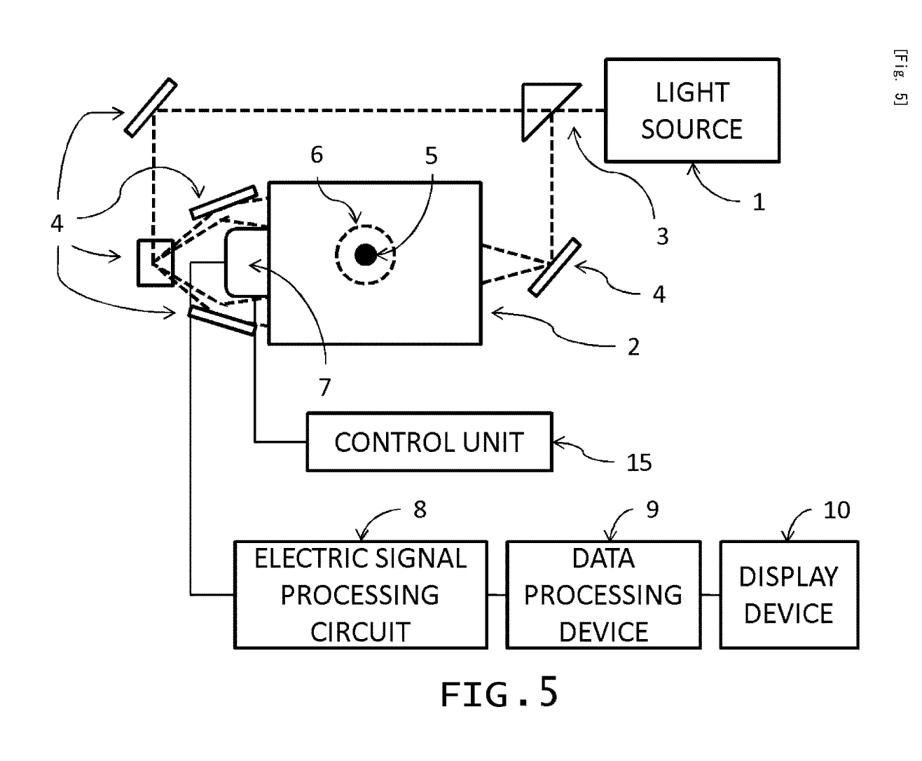

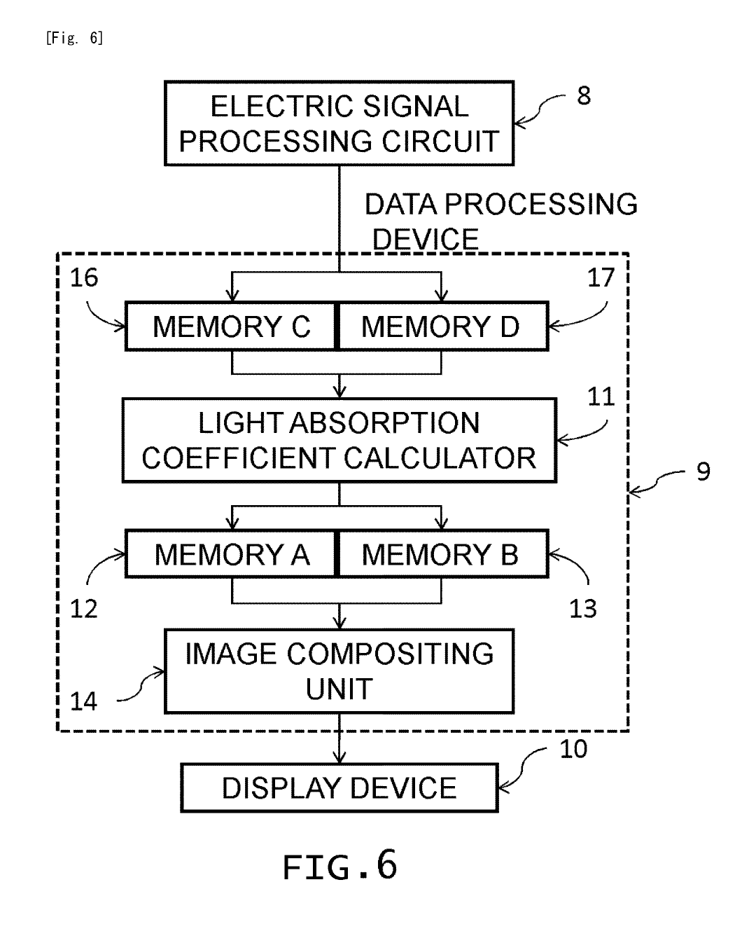

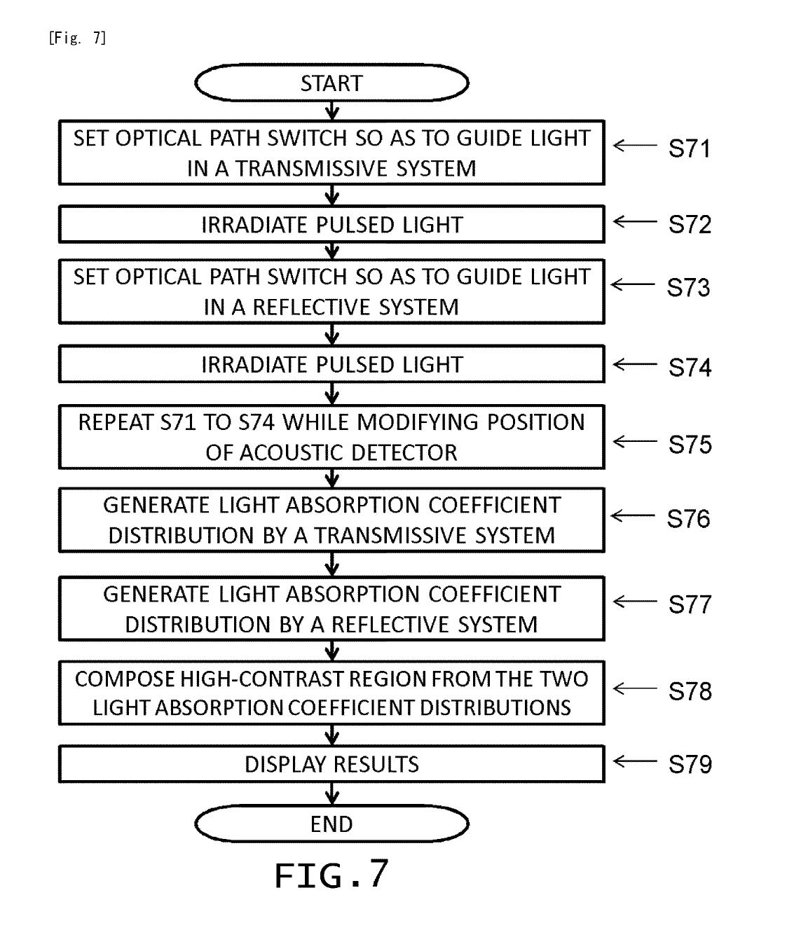

The implementation method of the present embodiment will be explained next with reference to FIG. 5, FIG. 6 and FIG. 7.

FIG. 5 is a block diagram of the entire configuration of the device according to the present embodiment. FIG. 6 is a diagram illustrating the internal configuration and control flow of the data processing device 9. FIG. 7 is a flow diagram illustrating an implementation method of the present invention.

In the present embodiment, as illustrated in FIG. 5, a control unit 15 for moving the position of the array-type acoustic detector 7 is added to the configuration of Embodiment 1. Signals at a plurality of positions can be acquired by way of the control unit 15. Therefore, the array-type acoustic detector 7 may be replaced by a single-element acoustic detector. The control unit 15 corresponds to the controller of the present invention.

In the data processing device of FIG. 6, a memory C 16 and a memory D 17 are supplementarily added to the configuration of Embodiment 1 illustrated in FIG. 3.

The implementation method of the present embodiment is explained next. In the flow chart of FIG. 7, firstly the optical path switch 3 is set so as to configure a transmissive irradiation system in which pulsed light is irradiated from a face opposing the array-type acoustic detector 7 (step S71). Next, pulsed light is irradiated from the light source 1 onto the object. The acoustic waves generated by the object that absorbs the light are acquired by the array-type acoustic detector 7, and are converted to an acoustic signal. The obtained acoustic signal is stored in the memory C 16 in the data processing device 9 (S72).

Next, the optical path switch 3 is set so as to configure a reflective irradiation system in which pulsed light is irradiated from the same face as that of the array-type acoustic detector 7 (S73).

Next, pulsed light is irradiated from the light source onto the object. The acoustic waves generated by the object that absorbs the light are acquired by the array-type acoustic detector 7, and are converted to an acoustic signal. The obtained acoustic signal is stored in the memory D 17 in the data processing device 9 (S74).

The array-type acoustic detector 7 is moved using the control unit 15, and the process of S71 to S74 is performed at a plurality of positions. The control unit 15 repeats the motion control of the array-type acoustic detector until measurement of the entirety of the object, or of a predetermined region thereof, is over (S75).

The light absorption coefficient calculator 11 in the data processing device 9 calculates respective light absorption coefficient distributions on the basis of the signals stored in the memory C 16 and the memory D 17, for each of the transmissive and reflective irradiation systems. The calculated light absorption coefficient distributions are stored in the memories A12 and B13 for each irradiation system (S76, S77). The memory A 12 stores the light absorption coefficient distribution derived from the obtained acoustic waves through irradiation in a transmissive system. The memory B 13 stores the light absorption coefficient distribution derived from the obtained acoustic waves through irradiation in a reflective system.

Next, the obtained light absorption coefficient distributions are composited by the image compositing unit 14 (S78). The method used in Embodiment 1 and Embodiment 3 can be employed for this procedure.

Lastly, the obtained data is displayed on the display device 10 (S79).

Through motion control, the method of the present embodiment allows imaging an object over a wide area; also, the time lag between measurements in the transmissive system and the reflective system is short. This allows smoothing jumps at joint portions, which is a concern in case of movement in the living body.

### Embodiment 5

An instance of the present embodiment is explained next in which contrast for each irradiation system is obtained on the basis of a measured light absorption coefficient distribution.

Contrast is the ratio of signal intensity between acoustic waves of the image of the light absorber and acoustic waves of a background portion. Therefore, contrast can be obtained by working out the respective signal intensities during measurement. The embodiment described herein is identical to Embodiment 1, except for the processing method in the image compositing unit 14.

The image compositing unit 14 calculates the intensity of a background portion, for each position in the object, on the basis of the obtained light absorption coefficient distribution at the respective irradiation system, transmissive and reflective.

In a case where a light absorber having a same light absorption coefficient is at dissimilar portions, the intensities of the respective acoustic signals that are obtained are proportional to the intensity of light. The intensity of light that reaches the respective light-absorbing bodies is determined by the degree of attenuation according to the distance traveled within the living body. Therefore, the degree of light attenuation at each position within the living body is calculated using an average light absorption coefficient of the living body, and is taken as the intensity of the image of the light absorber at the respective position. Contrast is calculated for each irradiation system on the basis of the signal intensity of the above-described background portion and the intensity of the image of the light absorber, and the light absorption coefficient distributions are composited on the basis of the calculation result.

### Example

Results obtained upon performing measurements according to Embodiment 1 of the present invention are described next. For comparison purposes, the results are given for measurements in each irradiation system, i.e. transmissive system, reflective system and two-side system.

The object is a simulated living body. The thickness of the object is 50 mm. Light absorber is disposed in the object at a distance of 10, 15, 20 and 25 mm from a probe. The optical characteristics and acoustic characteristics of the simulated living body conform to representative values of living bodies. The object was placed in air, and the optical components were adjusted in such a manner that nanosecond pulsed light having a wavelength of 1064 nm could be irradiated, using a Nd:YAG laser, in each irradiation system, i.e. transmissive system, reflective system and two-side system. A 2D array acoustic detector having a frequency band of 1 MHz (with plus or minus 40 percent margin) was adhered to the object. The 2 mm wide elements in the array were arranged as 23 elements lengthwise and 15 elements across, at a pitch of 2 mm.

The pulsed light was irradiated 30 times onto the object, in each irradiation system, i.e. transmissive system, reflective system and two-side system. The acoustic waves generated by the object were acquired by the 2D array acoustic detector. The obtained electric signal was amplified and was subjected to analog-digital conversion, to yield a digital signal. The analog-digital converter used herein had a sampling frequency of 20 MHz and a resolution of 12 bits. The obtained digital signals of the respective elements were averaged, and the averaged signal was subjected to differential and low-frequency pass filtering. The processed digital signals were subjected to back projection wherein the propagation time up to a respective voxel was adjusted and summated, and the result was divided by the distribution of light, to yield a light absorption coefficient distribution.

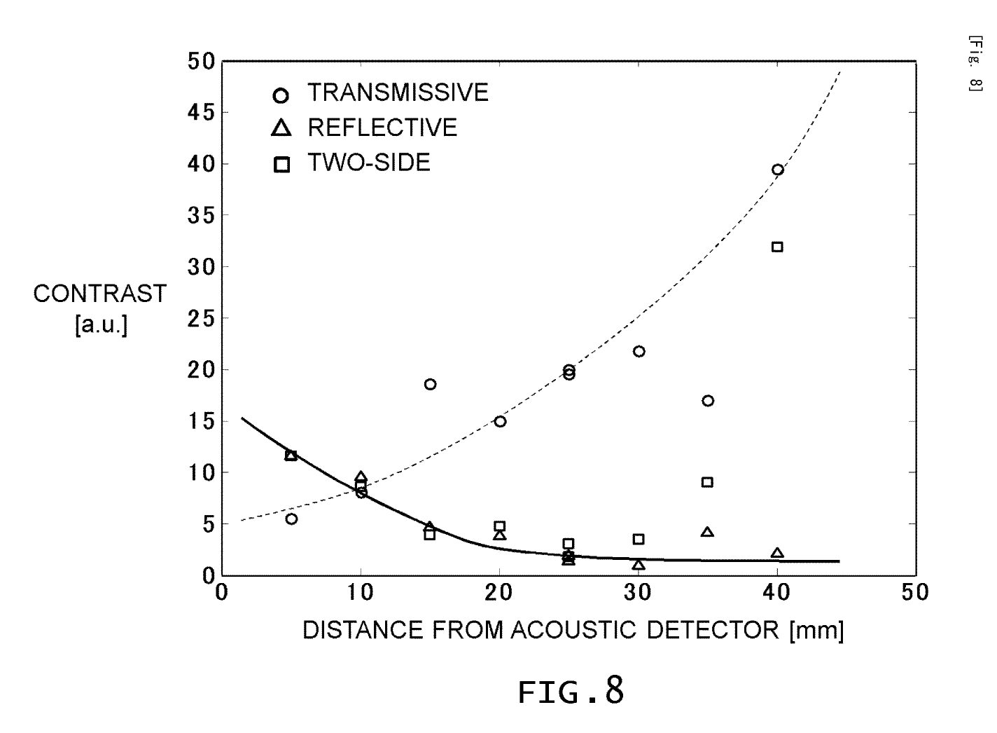

FIG. 8 is a graph illustrating the results of a calculation, on the basis of the obtained light absorption coefficient distribution, of contrast as a function of the distance from the acoustic detector, for each irradiation system. The measurements were carried out twice flipping the front-rear face of the light absorber. Contrast was calculated for a distance from the acoustic detector ranging from 10 mm to 40 mm.

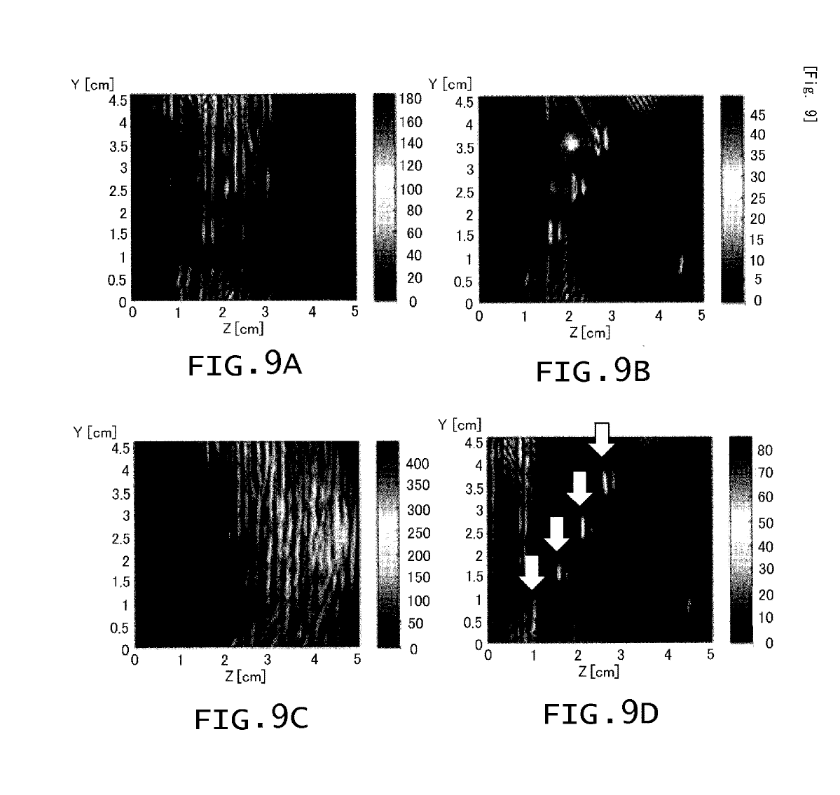

FIGS. 9A to 9D are maximum intensity projections (MIP) of the obtained light absorption coefficient distributions according to the respective irradiation systems. The acoustic detector is disposed at a position Z=0 cm, in a direction along the Z-axis. FIG. 9A corresponds to a two-side irradiation system, FIG. 9B corresponds to a transmissive irradiation system, and FIG. 9C corresponds to a reflective irradiation system. FIG. 9D shows the results obtained in the example. The four arrows in FIG. 9D correspond to a respective light absorber. In FIGS. 9A to 9C, the light absorber is at the same position as illustrated in FIG. 9D.

The results for each irradiation system, i.e. transmissive system, reflective system and two-side system in a comparative example of the present invention are explained next with reference to FIG. 8 and FIG. 9.

FIG. 8 shows that, in a transmissive system, contrast increases at a region near the irradiation source and far from the acoustic detector. On the other hand, light decreases, and contrast drops, at a region near the acoustic detector. As a result, the light absorber was indistinct at Z=1 cm in the MIP illustrated in FIG. 9B.

FIG. 8 shows that, in a reflective system, contrast increases at a region near the irradiation source and near the acoustic detector. On the other hand, light decreases, and contrast drops, at a region far from the acoustic detector. Also, signal ringing occurring at interfaces overlaps with the signal of the light absorber, and hence contrast is lower, in many regions, than in the case of a transmissive system. As a result, the light absorber was indistinct at Z=1.5 cm onwards in the MIP illustrated in FIG. 9C. The light absorber at Z=1.0 cm cannot be viewed distinctly, but that is because the color display range (depicted as an elongated gauge on the right of each picture in FIGS. 9A through 9D) was raised on account of noise at Z=2.5 cm onwards. Therefore, the light absorber is displayed at the contrast shown in FIG. 8 if the color display range is adjusted.

In a two-side system, as in FIG. 8, contrast increases at a region close to the irradiation source, on both sides. On the other hand, contrast drops at regions where light decreases, near the center. Also, interface signal ringing overlaps with the signal of the light absorber, as a result of which contrast is lower, in many regions, than in the case of a transmissive system. Accordingly, the light absorber was indistinct at a region from Z=1.5 to 3 cm in the MIP illustrated in FIG. 9A.

Examples in which the present invention is implemented are explained. FIG. 8 shows that reflective-system contrast is higher at regions at a distance shorter than 10 mm from the acoustic detector, while transmissive-system contrast is higher at regions at a distance greater than 10 mm from the acoustic detector. Therefore, the 0 to 10 mm region in the reflective system was cut out, the 10 to 50 mm region in the transmissive system was cut out, and the data items were joined together. As a result there was obtained a high-contrast image over the entire range from 0 to 50 mm, so that all four light-absorbing bodies could be viewed distinctly in the MIP depicted in FIG. 9D.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-205926, filed on Sep. 14, 2010, which is hereby incorporated by reference herein in its entirety.

1.-10. (canceled)

11. An object information obtaining apparatus comprising:
a light source configured to irradiate an object with light from a first direction and a second direction different from the first direction;
a detector configured to detect an acoustic wave generated by the object irradiated with light;
a calculator configured to obtain object information on the basis of acoustic waves detected by said detector; and
a generator configured to generate image data of the object on the basis of the object information,
wherein said calculator is configured to obtain first object information on the basis of the acoustic wave generated upon irradiation of the object with light from the first direction at a first timing, and to obtain second object information on the basis of the acoustic wave generated upon irradiation of the object with light from the second direction at a second timing different from the first timing, and
wherein said generator is configured to generate image data by combining the first object information and the second object information.

12. The object information obtaining apparatus according to claim 11, wherein one of the first direction and the second direction is a direction in which said light source irradiates the object with light from the same side as where said detector is located.

13. The object information obtaining apparatus according to claim 11, wherein one of the first direction and the second direction is a direction in which said light source irradiates the object with light from a side opposite where said detector is located.

14. The object information obtaining apparatus according to claim 11, wherein said generator is configured to select, for each region in the object and according to a predetermined criterion, image data of increased contrast in a case where first image data of the object and second image data of the object are generated on the basis of the first object information and the second object information, and combine the image data selected in each region.

15. The object information obtaining apparatus according to claim 14, wherein the predetermined criterion is distance from said detector to each region in the object.

16. The object information obtaining apparatus according to claim 14,
wherein the predetermined criterion is distance from said detector to each region in the object,
wherein one of the first direction and the second direction is a direction in which said light source irradiates the object with light from the same side as that where said detector is located and a direction in which said light source irradiates the object with light from a side opposite where said detector is located, and
wherein said generator is configured to select, in a region at a short distance from said detector, image data derived from acoustic waves generated upon irradiation of the object with light by said light source from the same side as where said detector is located, and select, in a region at a long distance from the detector, image data derived from acoustic waves generated upon irradiation of the object with light by said light source from a side opposite where said detector is located.

17. The object information obtaining apparatus according to claim 14, wherein said generator is configured to select a plurality of image data items upon selection of image data for each region in the object, and composite the selected image data items after multiplication of each of the image data items by a weighting coefficient in accordance with the distance from said detector to each region in the object.

18. The object information obtaining apparatus according to claim 14, wherein the predetermined criterion is a direction of irradiation at which image data of increased contrast selected for each region in the object is obtained from the first image data and the second image data derived from acoustic waves obtained beforehand through irradiation of a biological simulation material with light from the first direction and the second direction.

19. The object information obtaining apparatus according to claim 14, wherein said generator is configured to obtain, for each region in the object, a contrast that is based on a ratio between signal intensity of a background portion and signal intensity of a light absorber in the object, on the basis of the first image data and the second image data derived from acoustic waves obtained beforehand through irradiation of the object with light from the first direction and the second direction, and select image data in which the contrast is high.

20. The object information obtaining apparatus according to claim 11, further comprising a controller configured to move a position of said detector with respect to the object,
wherein said detector is configured to detect acoustic waves generated by the object at each position to which said detector is moved.

21. A control method of an object information obtaining apparatus that includes a light source configured to irradiate an object with light from a first direction and a second direction different from the first direction, a detector configured to detect an acoustic wave generated by the object irradiated with light, a calculator configured to obtain object information on the object on the basis of acoustic waves detected by the detector, and a generator configured to generate image data of the object on the basis of the object information, the method comprising:
a step of, by means of the light source, irradiating the object with light at a first timing from the first direction;
a step of, by means of the calculator, obtaining first object information corresponding to irradiation in the first direction at the first timing, on the basis of acoustic waves generated upon the irradiation;
a step of, by means of the light source, irradiating the object with light at a second timing different from the first timing from the second direction;
a step of, by means of the calculator, obtaining second object information corresponding to irradiation in the second direction at the second timing, on the basis of acoustic waves generated upon the irradiation; and
a step of, by means of the generator, generating image data by compositing the first object information and the second object information.
